(19) United States
(12) Patent Application Publication
(10) Pub. No.: US 2004/0122998 A1
(43) Pub. Date: Jun. 24, 2004

(54) Access control method and apparatus for a single hard disk with an automatic backup capability

(75) Inventors: Yuan-Lung Chang, Taipei City (TW); Yuan-Huei Chang, Taipei City (TW)

Correspondence Address: OSTROLENK FABER GERB & SOFFEN, 1180 AVENUE OF THE AMERICAS, NEW YORK, NY, 100368403

(73) Assignee: eTrunk Technologies Inc.

(21) Appl. No.: 10/639,196

(22) Filed: Aug. 11, 2003

(30) Foreign Application Priority Data
Dec. 20, 2002 (TW) 091136910

(51) Int. Cl. G06F 3/00

(52) U.S. Cl. 710/52

(57) ABSTRACT

An access control method is provided for a single hard disk partitioned into a data storage area and a data backup area. In response to a write command from a host terminal, a data write address for the data storage area and associated with the write command is translated into a backup write address for the data backup area. A processor receives and stores the data write address, write data associated with the write command, and the backup write address onto a data buffer, and stores the write data associated with the write command onto the data storage area at the data write address and onto the data backup area at the backup write address. In response to a read command from the host terminal, the processor reads data corresponding to the read command from one of the data storage area and the data backup area.

### CROSS-REFERENCE TO RELATED APPLICATION

This application claims priority of Taiwanese Application No. 091136910, filed on Dec. 20, 2002.

### BACKGROUND OF THE INVENTION

1. Field of the Invention

The invention relates to an access control method and apparatus, more particularly to an access control method and apparatus for a single hard disk with an automatic backup capability.

2. Description of the Related Art

Referring to FIG. 1, a conventional host system 2, such as a computer, includes a RAID storage device 1 constituted by an array of hard disks 11, and a RAID controller 3. The RAID controller 3 is used to configure the storage device 1 into a single virtual hard disk. A set of the hard disks 11 of the storage device 1 forms a backup hard disk for storing redundant information. Therefore, if one of the hard disks 11 malfunctions, the backup data stored on the backup hard disk can be retrieved to replace the corrupted data.

Since the storage device 1 is formed by a plurality of the hard disks 11, higher costs are incurred. Furthermore, a hard disk with a large storage capacity, such as 40 GB, is not necessary for data processing with a small data storage requirement. Moreover, it is not economical to replace a hard disk with a sector fault.

### SUMMARY OF THE INVENTION

Therefore, the object of the present invention is to provide an access control method and apparatus for a single hard disk with an automatic backup capability.

According to one aspect of the present invention, there is provided an access control method for a single hard disk having a total storage capacity (M). The access control method comprises the steps of:

a) partitioning the hard disk into a data storage area having a storage capacity (N) less than the total storage capacity (M), and a data backup area having a storage capacity (M-N);

b) in response to a write command from a host terminal,

b-1) translating a data write address for the data storage area and associated with the write command into a backup write address for the data backup area,

b-2) providing a processor which receives the data write address, write data associated with the write command, and the backup write address, and which stores the data write address, the write data, and the backup write address onto a data buffer, and

b-3) enabling the processor to store the write data associated with the write command onto the data storage area at the data write address and onto the data backup area at the backup write address; and

c) in response to a read command from the host terminal, enabling the processor to read data corresponding to the read command from one of the data storage area and the data backup area.

According to another aspect of the present invention, there is provided an access control apparatus for a single hard disk having a total storage capacity (M). The hard disk is to be partitioned into a data storage area having a storage capacity (N) less than the total storage capacity (M), and a data backup area having a storage capacity (M-N). The access control apparatus is responsive to write and read commands from a host terminal, and comprises:

a data buffer;

a processor connected to the data buffer;

a first transmission device adapted to connect the processor to the host terminal;

a second transmission device adapted to connect the processor to the hard disk;

a command interpreter connected to the first transmission device for interpreting the write and read commands from the host terminal; and

an address translator connected to the processor and the command interpreter;

wherein, in response to the write command from the host terminal,

the address translator translates a data write address for the data storage area and associated with the write command into a backup write address for the data backup area,

the processor receives the data write address and write data associated with the write command from the first transmission device, receives the backup write address from the address translator, stores the data write address, the write data, and the backup write address onto the data buffer, and stores the write data associated with the write command onto the data storage area at the data write address through the second transmission device and onto the data backup area at the backup write address through the second transmission device; and

wherein, in response to the read command from the host terminal, the processor reads data corresponding to the read command from one of the data storage area and the data backup area through the second transmission device.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic block diagram illustrating a conventional host system;

FIG. 2 is a schematic circuit block diagram illustrating the preferred embodiment of an access control apparatus for a single hard disk with an automatic backup capability according to the present invention;

FIG. 3 is a schematic view showing the hard disk in the preferred embodiment in a state of use;

FIG. 4 is a flow chart to illustrate access control of the hard disk in the preferred embodiment; and

FIG. 5 is a schematic view showing the hard disk in the preferred embodiment in another state of use.

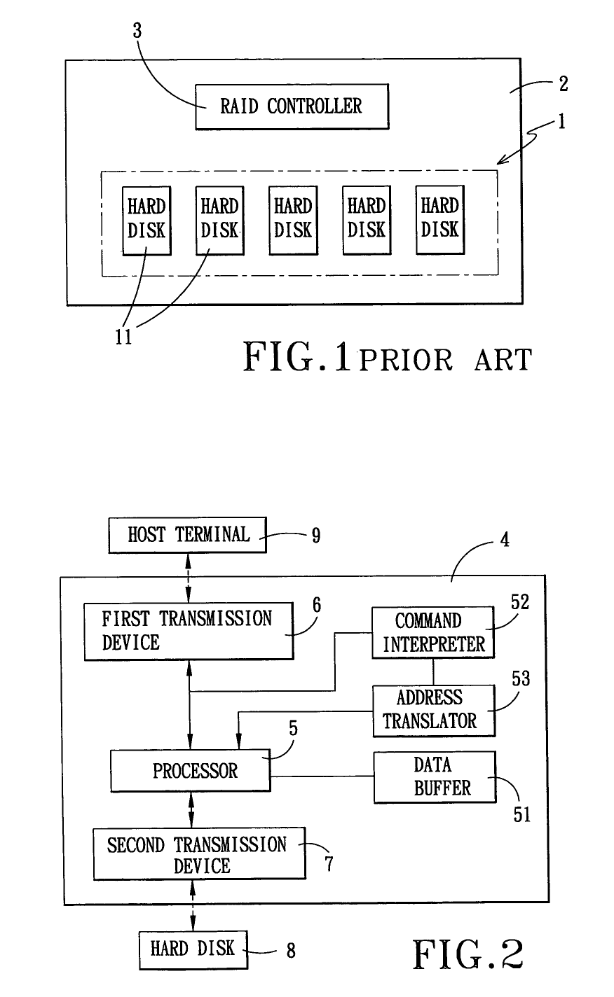

### DETAILED DESCRIPTION OF THE PREFERRED EMBODIMENT

Referring to FIG. 2, the preferred embodiment of an access control apparatus 4 for a single hard disk 8 according to the present invention is shown to include a data buffer 51, a processor 5, a first transmission device 6, a second transmission device 7, a command interpreter 52, and an address translator 53. The access control apparatus 4 is responsive to write and read commands from a host terminal 9.

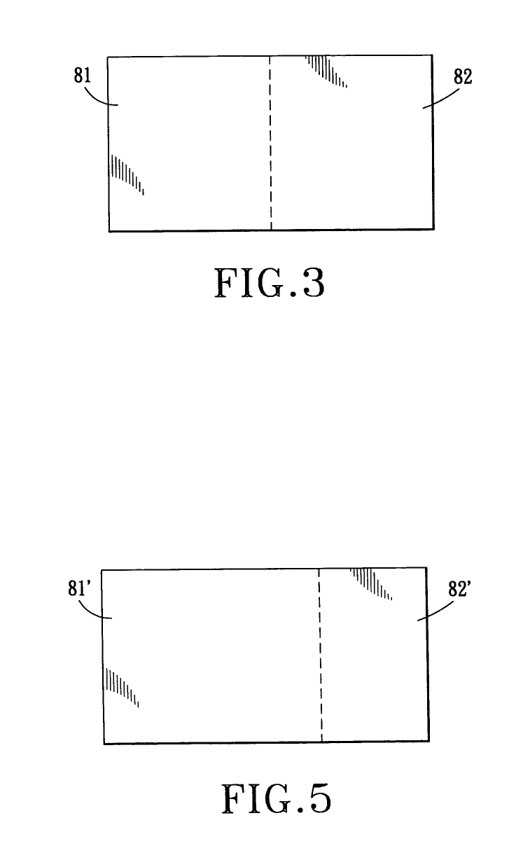

In this embodiment, the access control apparatus 4 is applied to a personal computer including a central processing unit serving as the host terminal 9 and the hard disk 8. The hard disk 8 has a total storage capacity (M). Alternatively, the access control apparatus 4 can be applied to a network system that includes the host terminal 9 and the hard disk 8 at a server end. In a state of use shown in FIG. 3, the hard disk 8 is to be partitioned into a data storage area 81 having a storage capacity (N) less than the total storage capacity (M), and a data backup area 82 having a storage capacity (M-N). In this embodiment, the storage capacity (N) of the data storage area 81 is equal to the storage capacity (M-N) of the data backup area 82.

The processor 5 is connected to the data buffer 51. The first transmission device 6 is adapted to connect the processor 5 to the host terminal 9. The second transmission device 7 is adapted to connect the processor 5 to the hard disk 8. The command interpreter 52 is connected to the first transmission device 6 for interpreting the write and read commands from the host terminal 9. The address translator 53 is connected to the processor 5 and the command interpreter 52. In this embodiment, each of the first and second transmission devices 6, 7 is an IDE interface or a SCSI interface.

Initially, the processor 5 is configured to report the total storage capacity of the hard disk 8 as being equal to the storage capacity (N) of the data storage area 81 in response to a capacity inquiry received from the host terminal 9 through the first transmission device 6. Thus, the host terminal 9 is not aware of the presence of the data backup area 82, and does not issue commands for directly accessing the data backup area 82.

Thereafter, in response to the write command from the host terminal 9, the address translator 53 translates a data write address for the data storage area 81 and associated with the write command into a backup write address for the data backup area 82. In this embodiment, since the storage capacities of the data storage area 81 and the data backup area 82 are equal, the backup write address translated by the address translator 53 is equal to the sum of the data write address and a total number of addressable locations of the data storage area 81. The processor 5 receives the data write address and write data associated with the write command from the first transmission device 6, receives the backup write address from the address translator 53, and stores the data write address, the write data, and the backup write address onto the data buffer 51. In this embodiment, when the processor 5 is in an idle state or upon detection that the data buffer 51 is full, the processor 5 is configured to store the write data associated with the write command onto the data storage area 81 at the data write address and onto the data backup area 82 at the backup write address through the second transmission device 7.

Moreover, in response to the read command from the host terminal 9, the address translator 53 translates a data read address for the data storage area 81 and associated with the read command into a backup read address for the data backup area 82. In this embodiment, the backup read address translated by the address translator 53 is equal to the sum of the data read address and the total number of addressable locations of the data storage area 81. The data read address and the data backup address are received by the processor 5. The processor 5 determines whether there exists sector fault in the data storage area 81 at the data read address, reads the data corresponding to the read command from the data storage area 81 at the data read address through the second transmission device 7 and provides the data read thereby to the host terminal 9 through the first transmission device 6 upon determination that no sector fault exists in the data storage area 81 at the data read address, and reads the data corresponding to the read command from the data backup area 82 at the backup read address through the second transmission device 7 and provides the data read thereby to the host terminal 9 through the first transmission device 6 upon determination that a sector fault exists in the data storage area 81 at the data read address.

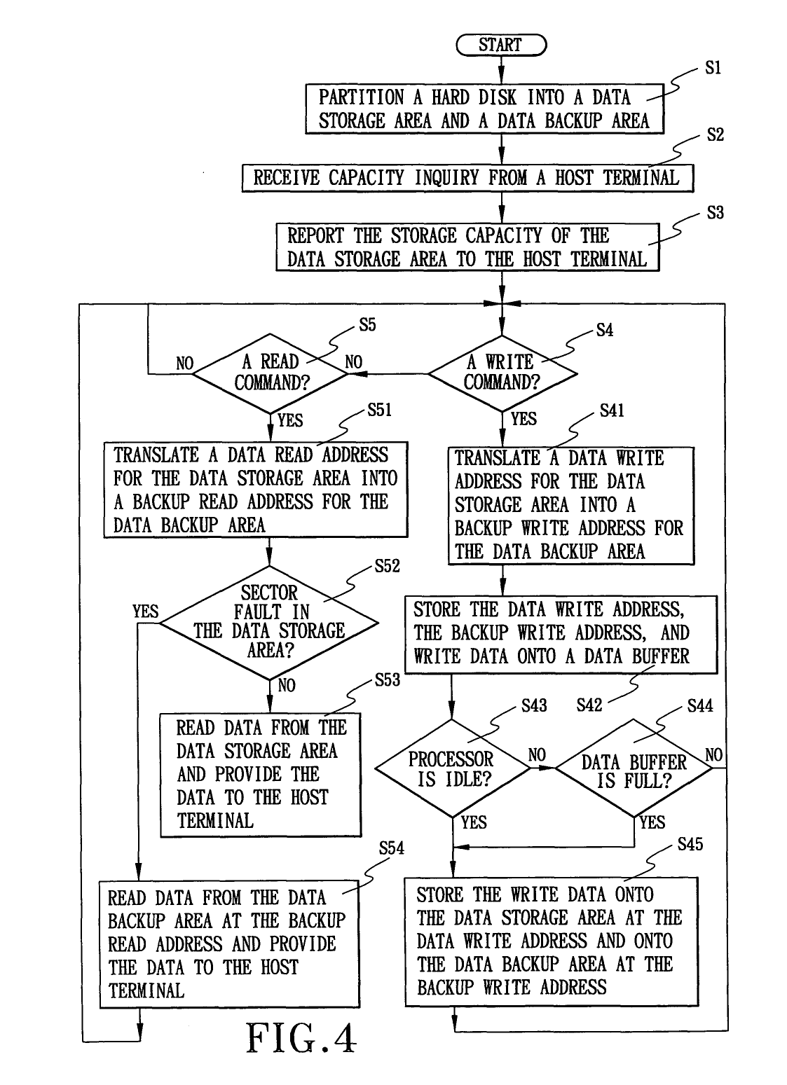

Referring to FIG. 4, there is shown a flow chart to illustrate access control of the hard disk 8 in the preferred embodiment. In step S1, the hard disk 8 is partitioned into the data storage area 81 having the storage capacity (N) and the data backup area 82 having the storage capacity (M-N). In step S2, the processor 5 receives capacity inquiry from the host terminal 9. In step S3, the processor 5 reports the total storage capacity of the hard disk 8 as being equal to the storage capacity (N) of the data storage area 81 in response to the capacity inquiry from the host terminal 9. In step S4, it is determined whether there is a write command from the host terminal 9. If yes, the flow proceeds to step S41, where the address translator 53 translates a data write address for the data storage area 81 and associated with the write command into a backup write address for the data backup area 82. Then, in step S42, the processor 5 receives the data write address, write data associated with the write command, and the backup write address, and stores the data write address, the write data and the backup write address onto the data buffer 51. In step S43, it is determined whether the processor 5 is in an idle state. If yes, the flow proceeds to step S45. In step S45, the processor 5 is configured to store the write data associated with the write command onto the data storage area 81 at the data write address and onto the data backup area 82 at the backup write address through the second transmission device 7. If it is determined in step S43 that the processor 5 is not in an idle state, the flow proceeds to step S44 to determine whether the data buffer 51 is full. If yes, the flow proceeds to step S45. Otherwise, the flow goes back to step S4. If it is determined in step S4 that there is no write command from the host terminal 9, the flow proceeds to step S5 to determine whether there is a read command from the host terminal 9. If yes, the flow proceeds to step S51. Otherwise, the flow goes back to step S4. In step S51, the address translator 53 translates a data read address for the data storage area 81 and associated with the read command into a backup read address for the data backup area 82. The data read address and the backup read address are received by the processor 5. Instep S52, the processor 5 determines whether there exists sector fault in the data storage area 81 at the data read address. Upon determination that no sector fault exists in the data storage area 81 at the data read address, the flow proceeds to step S53. In step 53, the processor 5 reads the data corresponding to the read command from the data storage area 81 at the data read address through the second transmission device 7, and provides the data read thereby to the host terminal 9 through the first transmission device 6. Upon determination that a sector fault exists in the data storage area 81 at the data read address, the flow proceeds to step S54. In step S54, the processor 5 reads the data corresponding to the read command from the data backup area 82 at the backup read address through the second transmission device 7, and provides the data read thereby to the host terminal 9 through the first transmission device 6.

Furthermore, the hard disk 8 can be configured for use in another state, as shown in FIG. 5, where the hard disk 8 is partitioned into a data storage area 81′ and a data backup area 82′. In this case, the data storage capacity (N) of the data storage area 81′ is larger than the storage capacity (M-N) of the data backup area 82′. As such, in step S45, the processor 5 stores the write data associated with the write command onto the data backup area 82′ at the backup write address in a compressed format according to a predetermined compression ratio (i.e., N/(M-N)). The backup write address translated by the address translator 53 is equal to the sum of total number of addressable locations of the data storage area 81′, and the product of the data write address and a data compression factor corresponding to the predetermined compression ratio. In step S54, the processor 5 decompresses the data read from the data backup area 82′ according to a predetermined decompression ratio (i.e., (M-N)/N) prior to providing the data to the host terminal 9. The backup read address translated by the address translator 53 is equal to the sum of the total number of the addressable locations of the data storage area 81′, and the product of the data read address and a data decompression factor corresponding to the predetermined decompression ratio.

It is noted that the access control apparatus 4 of the present invention can be provided on a motherboard of the computer in the form of hardware. Alternatively, the apparatus of this invention can be built into the host terminal 9 or the hard disk 8.

To sum up, the access control method and apparatus for a single hard disk according to the present invention partitions the hard disk into the data storage area and the data backup area such that, in response to a write command, it is possible to automatically backup write data associated with the write command onto the data backup area at a relatively lower cost.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

We claim:

1. An access control method for a single hard disk having a total storage capacity (M), comprising the steps of:
a) partitioning the hard disk into a data storage area having a storage capacity (N) less than the total storage capacity (M), and a data backup area having a storage capacity (M-N);
b) in response to a write command from a host terminal,
b-1) translating a data write address for the data storage area and associated with the write command into a backup write address for the data backup area,
b-2) providing a processor which receives the data write address, write data associated with the write command, and the backup write address, and which stores the data write address, the write data, and the backup write address onto a data buffer, and
b-3) enabling the processor to store the write data associated with the write command onto the data storage area at the data write address and onto the data backup area at the backup write address; and
c) in response to a read command from the host terminal, enabling the processor to read data corresponding to the read command from one of the data storage area and the data backup area.

2. The access control method as claimed in claim 1, wherein step (b-3) is performed when the processor is in an idle state.

3. The access control method as claimed in claim 1, wherein step (b-3) is performed when the data buffer is full.

4. The access control method as claimed in claim 1, wherein the storage capacities of the data storage area and the data backup area are equal, and the backup write address is equal to the sum of the data write address and a total number of addressable locations of the data storage area.

5. The access control method as claimed in claim 1, wherein the storage capacity of the data storage area is larger than the storage capacity of the data backup area, and in step (b-3), the processor stores the write data associated with the write command onto the data backup area at the backup write address in a compressed format according to a predetermined compression ratio.

6. The access control method as claimed in claim 5, wherein the backup write address is equal to the sum of a total number of addressable locations of the data storage area, and the product of the data write address and a data compression factor corresponding to the predetermined compression ratio.

7. The access control method as claimed in claim 1, wherein step (c) includes:
c-1) translating a data read address for the data storage area and associated with the read command into a backup read address for the data backup area, the data read address and the backup read address being received by the processor;
c-2) enabling the processor to determine whether there exists sector fault in the data storage area at the data read address;
c-3) enabling the processor to read the data corresponding to the read command from the data storage area at the data read address and to provide the data read thereby to the host terminal upon determination by the processor that no sector fault exists in the data storage area at the data read address; and
c-4) enabling the processor to read the data corresponding to the read command from the data backup area at the backup read address and to provide the data read thereby to the host terminal upon determination by the processor that a sector fault exists in the data storage area at the data read address.

8. The access control method as claimed in claim 7, wherein the storage capacities of the data storage area and the data backup area are equal, the backup write address being equal to the sum of the data write address and a total number of addressable locations of the data storage area, the backup read address being equal to the sum of the data read address and the total number of addressable locations of the data storage area.

9. The access control method as claimed in claim 7, wherein the storage capacity of the data storage area is larger than the storage capacity of the data backup area,
in step (b-3), the processor stores the write data associated with the write command onto the data backup area at the backup write address in a compressed format according to a predetermined compression ratio, and
in step (c-4), the processor decompresses the data read from the data backup area according to a predetermined decompression ratio prior to providing the data to the host terminal.

10. The access control method as claimed in claim 9, wherein:
the backup write address is equal to the sum of a total number of addressable locations of the data storage area, and the product of the data write address and a data compression factor corresponding to the predetermined compression ratio; and
the backup read address is equal to the sum of the total number of addressable locations of the data storage area, and the product of the data read address and a data decompression factor corresponding to the predetermined decompression ratio.

11. The access control apparatus as claimed in claim 1, further comprising the step of reporting the total storage capacity of the hard disk as being equal to the storage capacity (N) of the data storage area in response to a capacity inquiry from the host terminal.

12. An access control apparatus for a single hard disk having a total storage capacity (M), the hard disk to be partitioned into a data storage area having a storage capacity (N) less than the total storage capacity (M), and a data backup area having a storage capacity (M-N), said access control apparatus being responsive to write and read commands from a host terminal, and comprising:
a data buffer;
a processor connected to said data buffer;
a first transmission device adapted to connect said processor to the host terminal;
a second transmission device adapted to connect said processor to the hard disk;
a command interpreter connected to said first transmission device for interpreting the write and read commands from the host terminal; and
an address translator connected to said processor and said command interpreter;
wherein, in response to the write command from the host terminal,
said address translator translates a data write address for the data storage area and associated with the write command into a backup write address for the data backup area,
said processor receives the data write address and write data associated with the write command from said first transmission device, receives the backup write address from said address translator, stores the data write address, the write data, and the backup write address onto said data buffer, and stores the write data associated with the write command onto the data storage area at the data write address through said second transmission device and onto the data backup area at the backup write address through said second transmission device; and
wherein, in response to the read command from the host terminal, said processor reads data corresponding to the read command from one of the data storage area and the data backup area through said second transmission device.

13. The access control apparatus as claimed in claim 12, wherein said processor is configured to store the write data associated with the write command onto the data storage area at the data write address and onto the data backup area at the backup write address through said second transmission device when said processor is in an idle state.

14. The access control apparatus as claimed in claim 12, wherein said processor is configured to store the write data associated with the write command onto the data storage area at the data write address and onto the data backup area at the backup write address through said second transmission device upon detection that said data buffer is full.

15. The access control apparatus as claimed in claim 12, wherein the storage capacities of the data storage area and the data backup area are equal, and the backup write address translated by said address translator is equal to the sum of the data write address and a total number of addressable locations of the data storage area.

16. The access control apparatus as claimed in claim 12, wherein the storage capacity of the data storage area is larger than the storage capacity of the data backup area, and the processor is configured to store the write data associated with the write command onto the data backup area at the backup write address in a compressed format according to a predetermined compression ratio.

17. The access control apparatus as claimed in claim 16, wherein the backup write address translated by said address translator is equal to the sum of a total number of addressable locations of the data storage area, and the product of the data write address and a data compression factor corresponding to the predetermined compression ratio.

18. The access control apparatus as claimed in claim 12, wherein, in response to the read command from the host terminal:
said address translator translates a data read address for the data storage area and associated with the read command into a backup read address for the data backup area, the data read address and the data backup address being received by said processor;
said processor determines whether there exists sector fault in the data storage area at the data read address, reads the data corresponding to the read command from the data storage area at the data read address through said second transmission device and provides the data read thereby to the host terminal through said first transmission device upon determination that no sector fault exists in the data storage area at the data read address, and reads the data corresponding to the read command from the data backup area at the backup read address through said second transmission device and provides the data read thereby to the host terminal through said first transmission device upon determination that a sector fault exists in the data storage area at the data read address.

19. The access control apparatus as claimed in claim 18, wherein the storage capacities of the data storage area and the data backup area are equal, the backup write address translated by said address translator being equal to the sum of the data write address and a total number of addressable locations of the data storage area, the backup read address translated by said address translator being equal to the sum of the data read address and the total number of addressable locations of the data storage area.

20. The access control apparatus as claimed in claim 18, wherein the storage capacity of the data storage area is larger than the storage capacity of the data backup area,
said processor being configured to store the write data associated with the write command onto the data backup area at the backup write address through said second transmission device in a compressed format according to a predetermined compression ratio,
said processor decompressing the data read from the data backup area according to a predetermined decompression ratio prior to providing the data to the host terminal.

21. The access control apparatus as claimed in claim 20, wherein:
the backup write address translated by said address translator is equal to the sum of a total number of addressable locations of the data storage area, and the product of the data write address and a data compression factor corresponding to the predetermined compression ratio; and
the backup read address translated by said address translator is equal to the sum of the total number of addressable locations of the data storage area, and a product of the data read address and a data decompression factor corresponding to the predetermined decompression ratio.

22. The access control apparatus as claimed in claim 12, wherein each of said first and second transmission device is an IDE interface.

23. The access control apparatus as claimed in claim 12, wherein each of said first and second transmission devices is a SCSI interface.

24. The access control apparatus as claimed in claim 12, wherein said processor is configured to report the total storage capacity of the hard disk as being equal to the storage capacity (N) of the data storage area in response to a capacity inquiry received from the host terminal through said first transmission device.
